(19) United States
(12) Patent Application Publication
(10) Pub. No.: US 2014/0370743 A1
(43) Pub. Date: Dec. 18, 2014

(54) External Power Supply

(71) Applicant: Jim Maesnor, Carnation, WA (US)

(72) Inventor: Jim Maesnor, Carnation, WA (US)

(21) Appl. No.: 13/917,569

(22) Filed: Jun. 13, 2013

(51) Int. Cl. H01R 27/02

(52) U.S. Cl. CPC H01R 27/02
USPC 439/504

(57) ABSTRACT

The instant application discloses, among other things, an external power supply that may allow a cordless tool to be operated while connected to an external power source. Various adapters may be available to fit different cordless tools.

### FIELD

This disclosure relates generally to an External Power Supply.

### BACKGROUND

Users of electrically-powered tools often may need to balance the mobility of a cordless tool with the duration that the battery can be used. A cordless tool may typically have greater mobility compared to a corded tool, which may connect to an electrical wall socket; but a corded tool may be used for a greater duration, as the cordless tool may need to be recharged.

### SUMMARY

The instant application discloses, among other things an External Power Supply. An External Power Supply may be connected to a cordless tool, which may provide similar functionality to a corded tool. An External Power Supply may be connected to generator or wall outlet, and provide appropriate power to act as a battery replacement for a cordless tool. An External Power Supply may allow a cordless tool to be powered for extended periods of time. Additionally, the External Power Supply may provide battery charging functionality.

Cordless tools may have different battery requirements; different manufacturers may require different form factors, and one manufacturer may offer different form factors over time or for different battery voltage and current ratings. Various interchangeable connectors may be provided to allow one Battery Adapter to be used for various tools at various times. For example, one connector may fit a DeWALT® 20v drill, while another may fit a ROYOBI® 18v drill.

### BRIEF DESCRIPTION OF THE DRAWINGS

FIG. 1 illustrates a system where an External Power Supply may be used, according to one embodiment.

FIG. 2 illustrates parts of an External Power Supply, according to one embodiment.

FIG. 3 illustrates a side view of an External Power Supply used as a battery charger, according to one embodiment.

FIG. 4 illustrates a top view of an External Power Supply used as a battery charger, according to one embodiment.

FIG. 5 illustrates a top view of an External Power Supply with a pigtail outlet, according to one embodiment.

### DETAILED DESCRIPTION

A more particular description of certain embodiments of Smart Tiles may be had by references to the embodiments shown in the drawings that form a part of this specification, in which like numerals represent like objects.

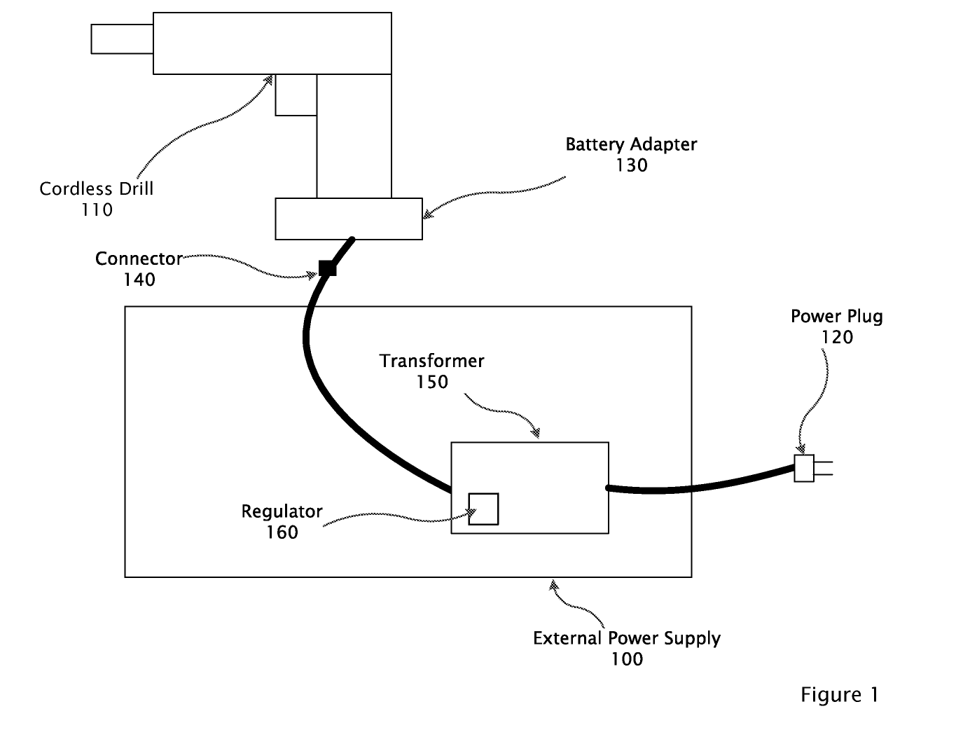

FIG. 1 illustrates a system where an External Power Supply 100 may be used according to one embodiment.

Cordless Drill 110 may have Battery Adapter 130 attached, using mechanical and electrical contacts normally used by a battery. Battery Adapter 130 may be coupled to External Power Supply 100 by Connector 140. Connector 140 may be used to couple various Battery Adapters 130 to External Power Supply 100 to permit batteries of various form factors to be replaced by a battery adapter. Transformer 150 may be powered by conventional 120 volt (v) alternating current (AC) by plugging Power Plug 120 into an outlet, which may be powered by an electrical grid or a generator, for example. Regulator 160 may be deployed within a housing for Transformer 150, or may be external. Regulator 160 may include a rectifier to provide a direct current (DC) output from an alternating current (AC) source. Regulator 160 may provide a consistent voltage level output from External Power Supply 100.

External Power Supply 100 may also have settings to configure input power specifications and output power specifications. For example, External Power Supply 100 may be switchable for 12v, 14v, 18v, or 20v DC output, and for 120v or 240v AC input. Settings may be selected manually by a user, or may be automatically determined by detecting a Battery Adapter's 130 requirements. For example, if a Battery Adapter 130 is attached to use with a DeWALT™ 18v device, External Power Supply 100 may detect the requirements and configure itself accordingly. In another embodiment, External Power Supply 100 may have a rotary switch to select a desired output voltage.

External Power Supply 100 may be deployed in a waterproof case.

One having skill in the art will recognize that many different configurations may be available and implemented in various ways well known on the art.

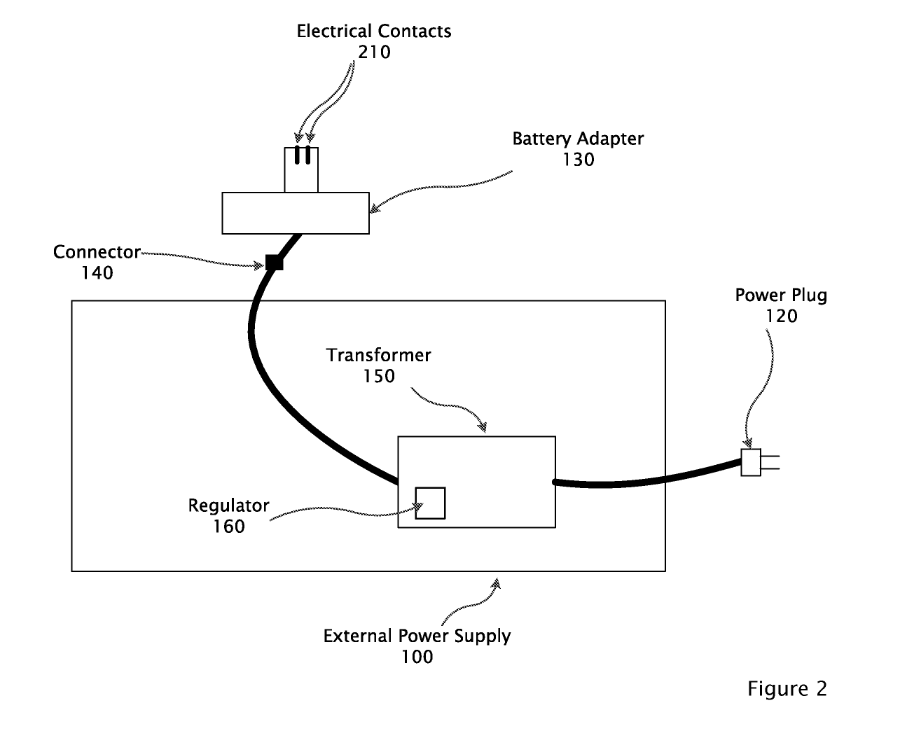

FIG. 2 illustrates parts of an External Power Supply, according to one embodiment. Battery Adapter 130 may have Electrical Contacts 210, which may match a location of electrical contacts on a battery that Battery Adapter 130 is replacing.

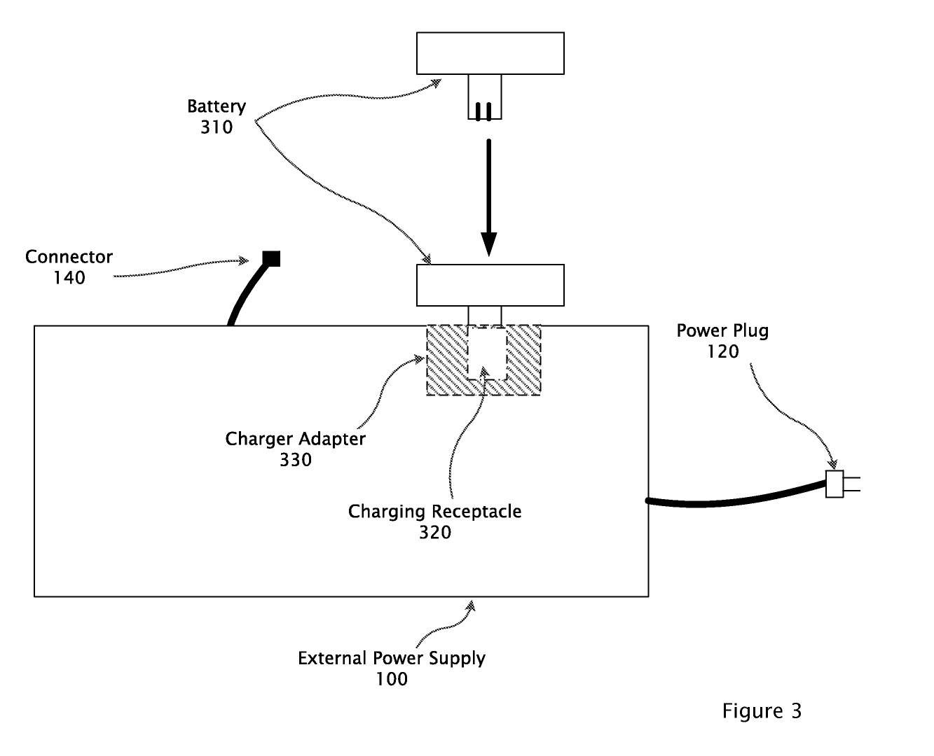

FIG. 3 illustrates a side view of an External Power Supply 100 used as a battery charger, according to one embodiment. Battery 310 may be inserted into a corresponding Charging Receptacle 320 on External Power Supply 100, which may allow Battery 310 to be charged. Charger Adapter 330 may be an insert which allows External Power Supply 100 to be used for charging batteries of differing form factors, electrical, and mechanical specifications.

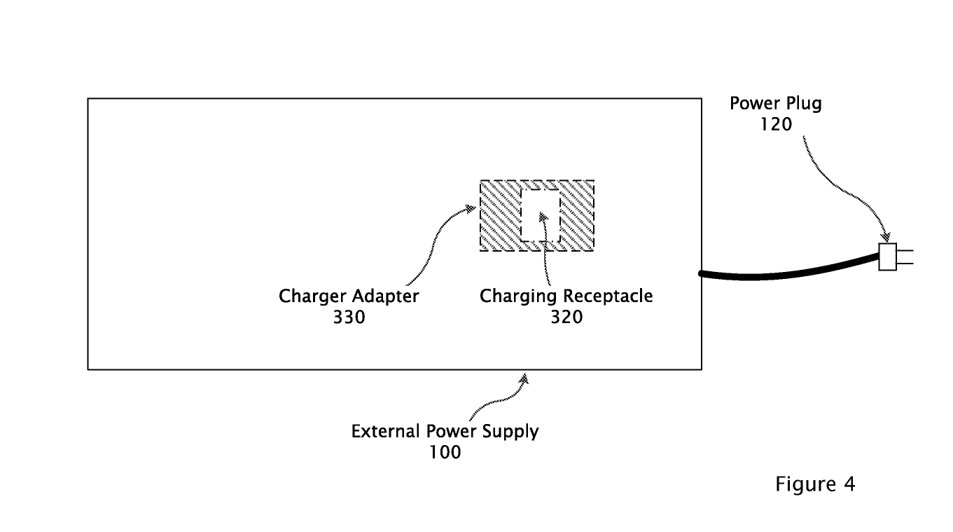

FIG. 4 illustrates a top view of an External Power Supply used as a battery charger, according to one embodiment. Charger Adapter 330 may be made of various materials, for example plastic, metal, carbon fiber, or combinations thereof. Charger Adapter 330 may adjust a mechanical fit of a battery into External Power Supply 100, it may include electrical circuitry to adjust electrical specifications to those appropriate for a type of battery, or it may contain an identifying characteristic, which may allow External Power Supply to automatically adjust electrical specifications to those appropriate for a type of battery. Charging Receptacle 320 may be various shapes and sizes to fit different batteries. Multiple Charger Adapter 330s may be available and swappable to allow one External Power Supply 100 to support charging various types of batteries at different times. External Power Supply 100 may also have a capability of charging several batteries at once, for example, by providing an ability to support a plurality of Charger Adapter 330s.

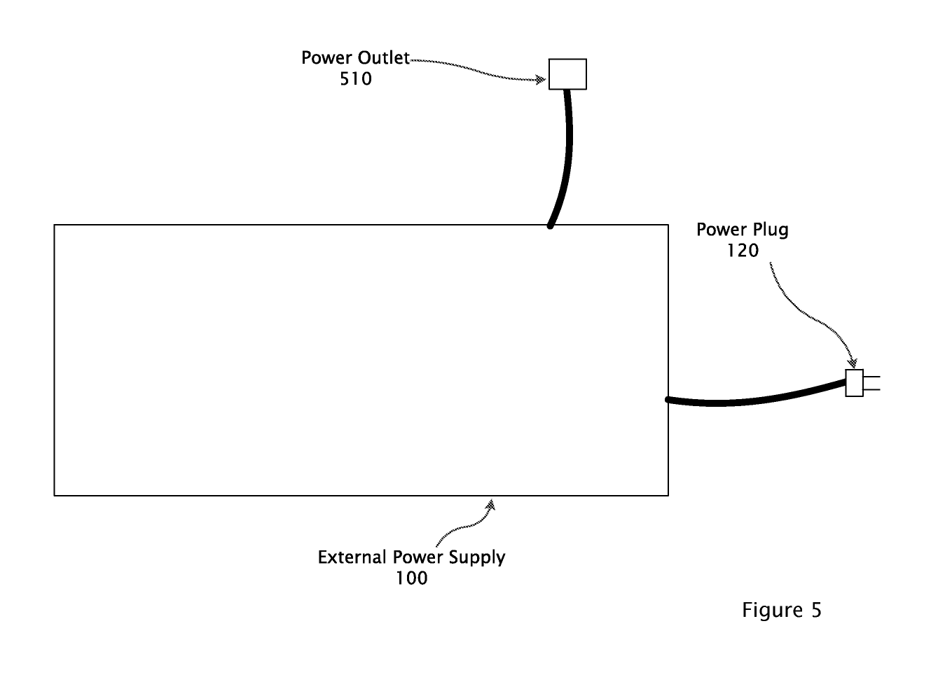

FIG. 5 illustrates a top view of an External Power Supply with a pigtail outlet, according to one embodiment. Power Outlet 510 may be used to power a battery charger or other device.

1. A system, comprising:
a power supply, the power supply including an AC-DC converter and enclosed in a case;
a power plug; the power plug electrically coupled to an AC input on the power supply and configured to electrically couple the AC input to a power outlet;
a connector, electrically coupled to a DC output on the power supply; and
at least one battery adapter electrically coupled to the connector; the battery adapter configured to replace a conventional battery on a cordless tool.

2. The system of claim 1, further comprising a charging receptacle, configured to hold and charge a battery for the cordless tool.

3. The system of claim 1, further comprising a pigtail receptacle, electrically coupled to the AC input.

4. The system of claim 1 wherein the case is waterproof.

5. The system of claim 1, further comprising a means to adjust a voltage supplied by the power supply to the connector.

6. The system of claim 5, wherein the means to adjust the voltage is a manual switch mounted on the power supply.

7. The system of claim 5 wherein the means to adjust the voltage comprises an electrical circuit which determines the coupled battery adapter and adjusts the voltage to an appropriate value.

8. The system of claim 5 wherein the voltage supplied by the power supply to the connector is selected from a group consisting of 12, 14, 18 and 20 volts.

9. The system of claim 5 wherein the case is waterproof.
